(19) United States
(12) Patent Application Publication
(10) Pub. No.: US 2025/0175728 A1
(43) Pub. Date: May 29, 2025

(54) SECURE CHARGING CASE FOR WIRELESS EARBUDS

(71) Applicant: QUALCOMM Incorporated, San Diego, CA (US)

(72) Inventors: Ravi SHEKHAR, Thubarahalli (IN); Chirag Manojkumar KHARVAR, Bangalore (IN); Jagdeep Kumar HANS, Bangalore (IN); Sachin TOMAR, Ghaziabad (IN); Shitiz KUMAR, BANGALORE (IN)

(21) Appl. No.: 18/523,141

(22) Filed: Nov. 29, 2023

(51) Int. Cl. H04R 1/10; H02J 50/80

(52) U.S. Cl. CPC H04R 1/1025; H02J 50/80; H04R 1/1016; H04R 2420/07

(57) ABSTRACT

Disclosed are techniques for wireless communication. In an aspect, a wireless earbud charging case receives authentication data for authenticating a pair of wireless earbuds to be connected to the wireless earbud charging case, stored in the wireless earbud charging case, or both, authenticates the pair of wireless earbuds based at least in part on the authentication data, and provides one or more services of the wireless earbud charging case to the pair of wireless earbuds based on authenticating the pair of wireless earbuds.

### BACKGROUND OF THE DISCLOSURE

### 1. Field of the Disclosure

Aspects of the disclosure relate generally to security for wireless earbud charging cases.

### 2. Description of the Related Art

Wireless earbuds (also known as “wireless in-ear headphones”) have become increasingly popular due to their small size and wireless connectivity to a user's device (e.g., smartphone, tablet computer, laptop computer, etc.). The small form factor makes wireless earbuds more portable than traditional headphones and the wireless connectivity eliminates the need for wires connecting the earbuds to each other and to the user's device. However, the small size of wireless earbuds limits their battery capacity, and thus, wireless earbuds come with a matching charging case. The charging case acts as a power bank for the earbuds and also keeps the earbuds safely together.

Currently, a set of wireless earbuds and the matching charging case are sold as a pair. However, with the ever-present demand for refined and increased user experience, the functionality of a charging case is expected to evolve beyond the mechanical functionalities of charging and keeping the wireless earbuds together. In the future, a charging case may provide a variety of services, such as providing speaker functionality, enabling features on earbuds facing user interface limitations, enabling features that are not available on the user's device, and so on.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a wireless earbud charging case includes receiving authentication data for authenticating a pair of wireless earbuds to be connected to the wireless earbud charging case, stored in the wireless earbud charging case, or both; authenticating the pair of wireless earbuds based at least in part on the authentication data; and providing one or more services of the wireless earbud charging case to the pair of wireless earbuds based on authenticating the pair of wireless earbuds.

In an aspect, a wireless earbud charging case includes one or more memories; one or more processors communicatively coupled to the one or more memories, the one or more processors, either alone or in combination, configured to: receive authentication data for authenticating a pair of wireless earbuds to be connected to the wireless earbud charging case, stored in the wireless earbud charging case, or both; authenticate the pair of wireless earbuds based at least in part on the authentication data; and provide one or more services of the wireless earbud charging case to the pair of wireless earbuds based on authenticating the pair of wireless earbuds.

In an aspect, a wireless earbud charging case includes means for receiving authentication data for authenticating a pair of wireless earbuds to be connected to the wireless earbud charging case, stored in the wireless earbud charging case, or both; means for authenticating the pair of wireless earbuds based at least in part on the authentication data; and means for providing one or more services of the wireless earbud charging case to the pair of wireless earbuds based on authenticating the pair of wireless earbuds.

In an aspect, a non-transitory computer-readable medium stores computer-executable instructions that, when executed by a wireless earbud charging case, cause the wireless earbud charging case to: receive authentication data for authenticating a pair of wireless earbuds to be connected to the wireless earbud charging case, stored in the wireless earbud charging case, or both; authenticate the pair of wireless earbuds based at least in part on the authentication data; and provide one or more services of the wireless earbud charging case to the pair of wireless earbuds based on authenticating the pair of wireless earbuds.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates various consumer devices in which aspects of the disclosure may be incorporated.

FIG. 2 illustrates a simplified diagram of an exemplary architecture of a device capable of implementing the techniques described herein.

FIG. 3 is a diagram illustrating an example mechanism for authentication between an advanced charging case and a pair of wireless earbuds, according to aspects of the disclosure.

FIG. 4 is a diagram illustrating a first-time configuration of fingerprint data on an advanced charging case, according to aspects of the disclosure.

FIG. 5 is a diagram illustrating a subsequent configuration of fingerprint data on an advanced charging case, according to aspects of the disclosure.

FIG. 6 illustrates an example method of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless communication. Some aspects more specifically relate to authentication between a wireless earbud charging case and a pair of wireless earbuds to be connected to the wireless earbud charging case, stored in the wireless earbud charging case, or both. In some examples, the wireless earbud charging case receives authentication data for authenticating the pair of wireless earbuds, authenticates the pair of wireless earbuds based at least in part on the authentication data, and provides one or more services of the wireless earbud charging case to the pair of wireless earbuds based on authenticating the pair of wireless earbuds.

Particular aspects of the subject matter described in this disclosure can be implemented to realize one or more of the following potential advantages. In some examples, by authenticating the wireless earbud charging case and the wireless earbuds, the described techniques can be used to prevent unauthorized use of the wireless earbud charging case.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Wireless earbuds typically communicate with each other and the audio source via BLUETOOTH®. As used herein, the term “wireless device” refers to any type of device (including wireless earbuds) that includes BLUETOOTH® capability, whether BLUETOOTH CLASSIC®, BLUETOOTH SMART®, BLUETOOTH SMART READY®, BLUETOOTH LOW ENERGY®, or other. In general, a wireless device may be any wireless communication device, such as a mobile phone, router, tablet computer, laptop computer, tracking device, wearable (e.g., smartwatch, wireless headset, wireless earbuds, glasses, augmented reality (AR)/virtual reality (VR) headset, etc.), in-vehicle communication device, portable hard drive, computer gaming device, pointing device (e.g., a mouse, keyboard, pen, trackball, joystick, etc.), Internet of Things (IoT) device (e.g., home appliance, television, smart speaker, etc.), etc., capable of communicating with other wireless devices over a BLUETOOTH® link. In addition to being BLUETOOTH® capable, a wireless device may be able to communicate over other types of wireless networks, such as a wireless local area network (WLAN) (e.g., based on Institute of Electrical and Electronics Engineers (IEEE) 802.11, etc.) or a cellular network (e.g., Long-Term Evolution (LTE), 5G New Radio, etc.), to name a few examples. Such a wireless device may be referred to interchangeably as a “user equipment” (UE), an “access terminal” (AT), a “client device,” a “subscriber device,” a “subscriber terminal,” a “subscriber station,” a “user terminal” (UT), a “mobile device,” a “mobile terminal,” a “mobile station,” or variations thereof.

A wireless device may be configured as a controller or a remote (or “peripheral”). Often the controller is a smartphone, tablet, or personal computer. A controller may set up a wireless network with multiple remotes, where connections are established between the controller and each remote. A wireless device may also be configured as a server or a client. In practice, the server may be thought of as having data of interest, whereas a client connects with the server to request the data and perhaps modify the state of the server. Usually, the controller is the client and a remote is the server.

For example, a BLUETOOTH® home thermostat may store temperature values over some period of time and perform as a server and remote to a smartphone when the smartphone is brought in proximity to the home thermostat. The home thermostat may advertise itself so that when the smartphone is in range a connection is established with the smartphone as the controller and the home thermostat as the remote. In this example, the smartphone performs as the client, requesting the stored temperature values from the home thermostat. Based upon an application running on the smartphone, the smartphone may change the state of the thermostat whereby the home thermostat's temperature setting is raised or lowered depending upon the stored temperature readings and other information that the smartphone may access from the home thermostat or perhaps from cloud-based databases.

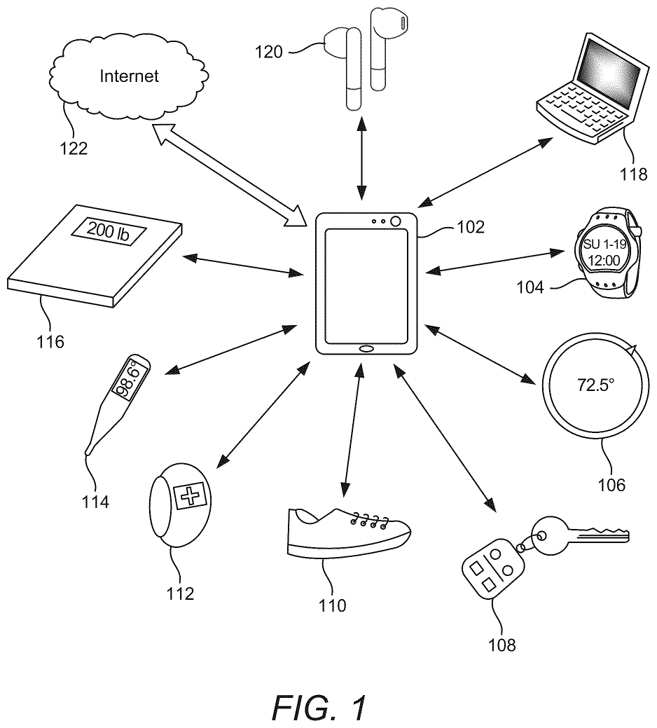

BLUETOOTH® technology has found applications in many devices in common use around the home, office, factory, etc. For example, FIG. 1 illustrates a wireless network in which a smartphone 102 may be a controller and client to multiple BLUETOOTH® capable devices: a wristwatch 104 with a sensor to measure pulse rate; a home thermostat 106; a key fob 108 with stored car seat settings and other car preferences; an athletic shoe 110 with a pedometer; a wrist band 112 with a sensor to measure blood pressure and heart rate; a personal thermometer 114; a weight scale 116; a laptop 118; and wireless earbuds 120. The smartphone 102 may be connected to the Internet 122 so that various databases may be accessed to store readings or to adjust the state of some of the BLUETOOTH® devices, or perhaps to alert a health care professional or emergency service personnel if a reading from a BLUETOOTH® device indicates a health issue or urgent situation.

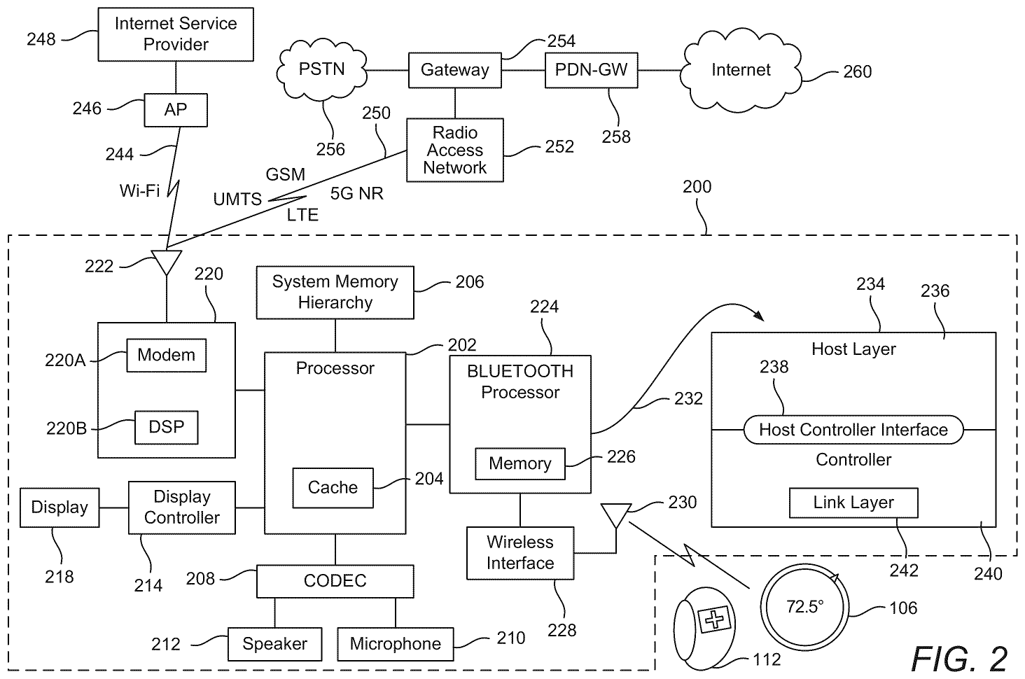

FIG. 2 illustrates a wireless device 200 in which aspects of the disclosure may find application. The wireless device 200 may be any one of a number of communication devices, such as a smartphone, tablet, or laptop, to name a few examples. The wireless device 200 may be a controller wireless device or a peripheral wireless device, or may at times operate as a controller wireless device or a peripheral wireless device. The main processor 202 for the wireless device runs applications visible to the user of the wireless device and includes a cache memory 204 as well as an interface to store and retrieve data and instructions from off-chip memory, represented in FIG. 2 as the system memory hierarchy 206. The system memory hierarchy 206 may comprise various volatile and non-volatile memory systems. Also shown in FIG. 2 is the CODEC (coder-decoder) 208 for interfacing with the microphone 210 and the speaker 212. The display controller 214 provides an interface to the display 218 so that the user may easily interact with the wireless device 200.

The wireless device 200 may be capable of interfacing with other wireless networks by way of a transceiver 220, also referred to as a wireless interface, and one or more antennas 222. The transceiver 220 is illustrated as comprising a modem 220A and a digital signal processor (DSP) 220B, although in practice other kinds of modules may be employed, all or some such modules may be integrated on a single chip, and some of the modules may be integrated with the processor 202.

The main processor 202 may implement a BLUETOOTH CLASSIC®, BLUETOOTH SMART®, BLUETOOTH SMART READY®, and/or BLUETOOTH LOW ENERGY® protocol stack in which instructions for performing some or all of the protocol stack are stored in the system memory hierarchy 206. However, in the example of FIG. 2, a separate chip or an embedded hardware core, shown as a BLUETOOTH® processor 224, implements the portions of the protocol stack to perform the BLUETOOTH® functionality described herein. The BLUETOOTH® processor 224 comprises a memory 226, shown as an on-chip memory, although the memory 226 may be part of a memory hierarchy in which some memory also resides off-chip. A wireless interface 228 provides an interface to one or more antennas 230, suitable for operating in the designated frequency spectrum utilized by BLUETOOTH®. Communication may be made with any number of BLUETOOTH® capable devices, such as the wireless earbuds 120.

The arrow 232 serves to indicate that the BLUETOOTH® processor 224 performs the protocol stack, represented by the box labeled 234. Shown in the protocol stack 234 are the host layer 236, the host controller interface 238, and the controller 240. The controller 240 includes the link layer 242. For ease of illustration, not all layers are shown. Software or firmware running on the BLUETOOTH® processor 224 may implement all or some of the layers in the protocol stack 234, and special purpose hardware, such as an ASIC, may also implement some of the layers.

It is to be appreciated that the BLUETOOTH® processor 224 may represent more than one processor, where for example a programmable processor may implement the host layer 236 and a DSP may implement some or all of the actions performed by controller 240, except perhaps for the physical layer (not shown). The instructions for implementing some or all of the BLUETOOTH® functionality described herein may be stored in a memory, such as for example the memory 226. The memory 226 may be referred to as a non-transitory computer readable medium.

The wireless device 200 may participate in one or more wireless networks to gain access to the Internet. In the example of FIG. 2, the wireless device 200 has a Wi-Fi link 244 to an access point (AP) 246, where an Internet service provider (ISP) 248 provides access to the Internet.

The wireless device 200 may also have the functionality of a cellular phone so as to participate in any one of a number of cellular networks. For example, the wireless device 200 may have an air interface link 250 that may, for example, be compatible with various cellular networks, such as Global System for Mobile communications (GSM), Universal Mobile Telecommunications Systems (UMTS), Long-Term Evolution (LTE), 5G New Radio (NR), and the like. The air interface link 250 provides communication to a radio access network 252, where the architecture of the radio access network 252 depends upon the type of cellular network standard. For example, in the case of GSM, the radio access network 252 may include a base station, for UMTS it may include a Node-B, for LTE it may include an eNode-B, and for 5G NR it may include a gNode-B, as specified by 3GPP (3rd Generation Partnership Project).

Not all functional units are illustrated in FIG. 2 for providing a connection to the Internet, but for ease of illustration several components are shown, such as the gateway 254 that generically represents several network components for providing communication to the public switched telephone network (PSTN) 256 and the packet data network gateway (PDN-GW) 258, where the PDN-GW 258 provides the proper communication interface to the Internet 260. As is apparent, the network architecture illustrated in FIG. 2 for the Wi-Fi link 244 and the air interface link 250 is simplified for ease of illustration.

As noted above, currently, a set of wireless earbuds and the matching charging case are sold as a pair. However, with the ever-present demand for refined and increased user experience, the functionality of a charging case is expected to evolve beyond the mechanical functionalities of charging and keeping the wireless earbuds together. In the future, a charging case may provide a variety of services, such as providing speaker functionality, enabling features on earbuds facing user interface limitations, enabling features that are not available on the user's device, and so on.

In addition, there are various scenarios where a user may want to purchase a standalone charging case, including from a different vendor than the earbuds. For example, these scenarios include the battery life of the existing charging case being degraded, the user wanting to purchase a charging case with a greater battery capacity, the user wanting a charging case with new/additional features (e.g., a charging case with a display, a tactile interface, etc.), the user needing to replace the existing charging case (e.g., because the charging case was broken or lost), the user wanting to maintain multiple charging cases at different locations (e.g., one at home, one at work, one in the car, etc.), and so on.

In the future, where a wireless earbud charging case is a provider of one or more services to the wireless earbuds and the earbuds are a consumer of those services, the services need to be protected from unauthorized access. This security can be broadly divided into two categories. First, security from the wireless earbuds to the charging case. Here, when a pair of wireless earbuds is placed into the charging case, it should not be able to access services of the charging case without authorization. Second, security from the charging case to the wireless earbuds. Here, when the wireless earbuds are placed into the charging case, the charging case should not be able to access any security related information from the earbuds (e.g., pairing data) unless it is authorized.

With a feature-loaded charging case, the first issue to address is safely introducing the charging case into the eco system of the earbuds and the user's wireless device (e.g., a smartphone). With more and more features expected to be implemented by a charging case, the charging case should not become the weakest link to enable a malicious actor to break into and obtain sensitive user information.

The above issue showcases a lack of authentication and authorization between the earbuds and the charging case, which can result in unauthorized service access on one or both sides (i.e., the earbuds and/or the charging case). The services can be broadly categorized into two types. First are public services, which are the services that are provided by the charging case to the earbuds without any authorization (e.g., simple charging functionality, charge level display). Second are private services, which are the services that are provided by the charging case to the earbuds only when the earbuds are authorized (e.g., fast charging, display control functionality, etc.).

With advanced (standalone) charging cases being introduced, it becomes very important for authentication and authorization to be carried out with the earbuds to enable the earbuds to access various services provided by the charging case. Accordingly, the present disclosure provides an authentication mechanism between the charging case and the earbuds.

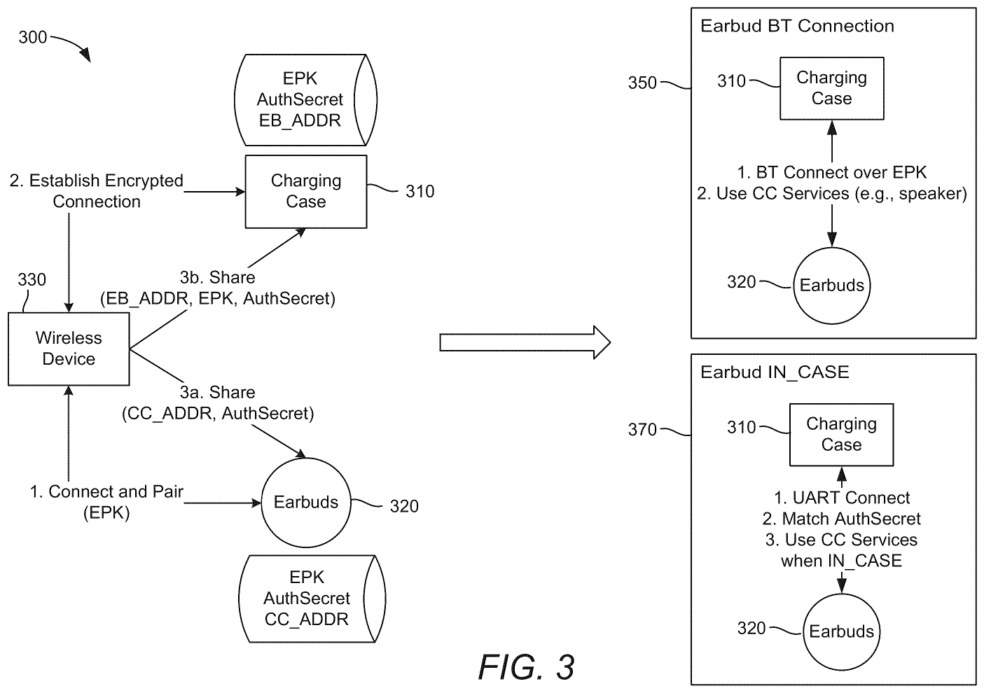

FIG. 3 is a diagram 300 illustrating an example mechanism for authentication between an advanced charging case 310 and a pair of wireless earbuds 320 (e.g., wireless earbuds 120), according to aspects of the disclosure. In the example of FIG. 3, the advanced charging case has wireless connectivity, which may be of any type, such as BLUETOOTH®, Wi-Fi, or the like. In some cases, the advanced charging case 310 may be an example of the wireless device 200 in FIG. 2, and may include some or all of the components of the wireless device 200 illustrated in FIG. 2.

At stage 1, the user's wireless device 330 (e.g., a smartphone, tablet, etc.) connects to and pairs with the wireless earbuds 320 via a pairing procedure (e.g., a BLUETOOTH® pairing procedure), resulting in the wireless device 330 storing an earbud pairing key (EPK). In some cases, the wireless device 330 may be an example of the wireless device 200 in FIG. 2, and may include some or all of the components of the wireless device 200 illustrated in FIG. 2.

The EPK is used for encrypting data exchanged between the wireless device 330, the advanced charging case 310, and the wireless earbuds 320. In a regular connection, the EPK represents the encryption key generated and shared by the respective wireless connections. In account-based pairing, the EPK may be linked with some Cloud-based account (e.g., GOOGLE®, AMAZON®, etc.). The wireless device 330 can fetch this key and share it with the wireless earbuds 320 for future communications (e.g., Fast Pair for BLUETOOTH®).

At stage 2, the wireless device 330 establishes an encrypted connection with the advanced charging case 310. Based on the capabilities of the advanced charging case 310, one of the following is performed. If the advanced charging case 310 has wireless connectivity, the user makes the advanced charging case 310 discoverable for pairing by, for example, pushing a pairing button on the advanced charging case 310. The discoverable advanced charging case 310 is now detectable by the wireless device 330, which can then establish an encrypted connection with the advanced charging case 310. For example, where the wireless device 330 and the advanced charging case 310 are BLUETOOTH® capable, the wireless device 330 and the advanced charging case 310 may pair with each other via BLUETOOTH® connectivity. If, however, the advanced charging case 310 does not have wireless connectivity, the wireless device 330 can connect to the advanced charging case 310 via wired means (e.g., Universal Serial Bus (USB).

At stage 3, the wireless device shares information with the advanced charging case 330 and the wireless earbuds 320. This may be accomplished in two parts. First, at stage 3a, the wireless device 330 shares the parameters CC_ADDR (the address of the charging case) and AuthSecret with the wireless earbuds 320 over a wireless connection (e.g., a BLUETOOTH® connection) using the EPK. The CC_ADDR parameter is the address of the advanced charging case 310 used by the wireless earbuds 320 to establish a wireless connection with the advanced charging case 310. The AuthSecret parameter is a shared secret between the wireless device 330, the advanced charging case 310, and the wireless earbuds 320.

At stage 3b, the wireless device 330 shares the parameters EPK, EB_ADDR (the address of the wireless earbuds), and AuthSecret with the advanced charging case 310 over a wireless connection (e.g., a BLUEOOTH® connection) if the advanced charging case 310 supports wireless connectivity. Alternatively, the advanced charging case 310 may receive the authentication data (here, the EPK, EB_ADDR, and AuthSecret) from a server (e.g., a cloud server, a network server, etc.) over a wireless connection, if capable of such a connection. Otherwise, the wireless device 330 shares the parameters EPK, EB_ADDR, and AuthSecret with the advanced charging case 310 over a wired connection (e.g., a USB connection). The EB_ADDR parameter is the address of the wireless earbuds and is used by the advanced charging case 310 to establish a wireless connection with the wireless earbuds 320.

Once the sharing procedure illustrated in FIG. 3 is finished, both the wireless earbuds 320 and the advanced charging case 310 have the EPK and a generated AuthSecret value. This authentication can be used when establishing wireless connections between the advanced charging case 310 and the wireless earbuds 320 or to protect the information on a wired connection between the advanced charging case 310 and the wireless earbuds 320. The AuthSecret specifically can be used by the wireless earbuds 320 and the advanced charging case 310 to authenticate each other to use different services (provided by the advanced charging case 310).

For example, block 350 illustrates communication between the advanced charging case 310 and the wireless earbuds 320 over a BLUETOOTH® (denoted “BT”) connection. Specifically, at stage 1, the advanced charging case 310 and the wireless earbuds 320 pair with each other using the EPK. At stage 2, the wireless earbuds 320 can use one or more services of the advanced charging case 310.

Similarly, block 370 illustrates communication between the advanced charging case 310 and the wireless earbuds 320 when the wireless earbuds 320 are in the advanced charging case 310 (denoted “IN_CASE”). Specifically, at stage 1, the wireless earbuds 320 connect to the advanced charging case 310 via a wired/pin connection (e.g., a universal asynchronous receiver-transmitter (UART) connection). At stage 2, the advanced charging case 310 and the wireless earbuds 320 exchange and compare their respective AuthSecret values. If they match, then at stage 3, the wireless earbuds 320 can use one or more in-case services of the advanced charging case 310.

Note that once authenticated, the user, via the wireless device 330, can determine which services provided by the advanced charging case 310 require authentication between the advanced charging case 310 and the wireless earbuds 320. For example, the user may not require authentication for the charging functionality provided by the advanced charging case 310 but may require authentication for all other services. Alternatively, the advanced charging case 310 may not have the capability to authenticate for only a subset of services but may instead require authentication for any and all services.

In some cases, out-of-band techniques can be used for authentication between an advanced charging case and a pair of wireless earbuds. These authentication techniques may use various sensors that may be present on the advanced charging case. For example, where an advanced charging case is equipped with a fingerprint sensor, fingerprint data can be used for authentication.

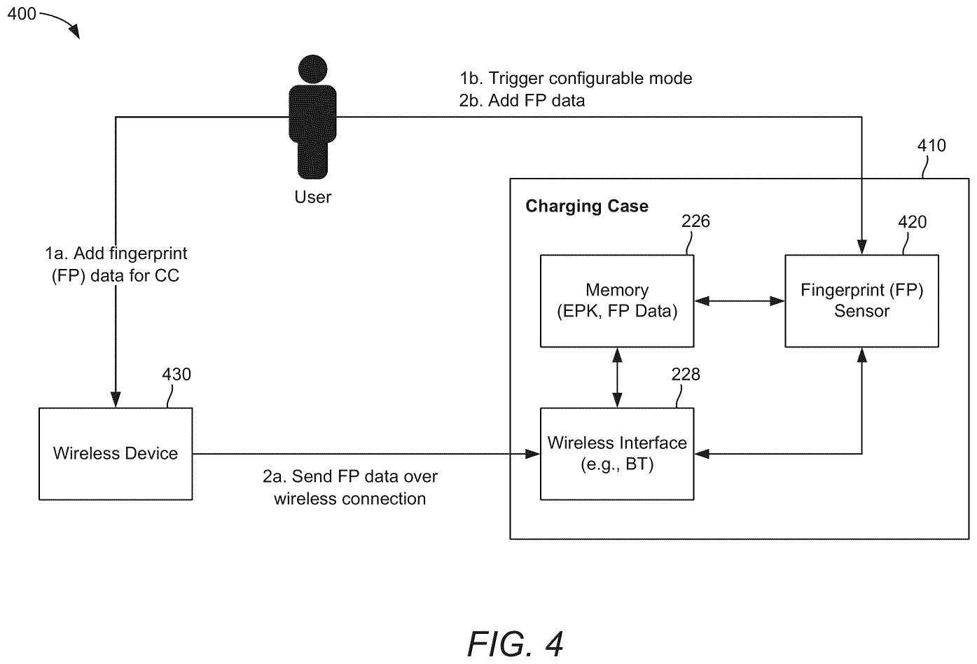

FIG. 4 is a diagram 400 illustrating a first-time configuration of fingerprint data on an advanced charging case 410, according to aspects of the disclosure. The advanced charging case 410 may correspond to any of the advanced charging cases disclosed herein, such as the advanced charging case 310. In the example of FIG. 4, the advanced charging case 410 does not have any stored fingerprint data and is being configured for the first time.

Triggering the configuration mode on the advanced charging case 410 for the first time may be done through the user's wireless device 430 (e.g., wireless device 330) as the wireless device 430 should be able to connect to and pair with the advanced charging case 410 and send commands to it. Any wireless connection can be used to achieve this, such as BLUETOOTH®, Wi-Fi, or the like.

The fingerprint sensor 420 may be used in two ways based on where the fingerprint configuration is being performed. If the fingerprint configuration is being performed on the user's wireless device 430 (e.g., smartphone, tablet, etc.), then at stage 1a, an application installed on the user's wireless device 430 may obtain fingerprint data and, at stage 2a, transfer this data to the advanced charging case 410 over a wireless connection (e.g., a BLUETOOTH® connection). The advanced charging case then stores this data in its memory.

If the fingerprint configuration is being performed on the advanced charging case 410, then at stage 1b, the advanced charging case 410 is placed into configuration mode and, at stage 2b, the fingerprint data are taken on the advanced charging case 410 and stored into its memory. Various ways to trigger configuration mode on the advanced charging case 410 will be discussed below. The advanced charging case 410 entering configurable mode may be indicated to the user in various ways, such as one or more blinking lights, a display message, a voice prompt, and/or the like.

In some cases, when adding fingerprint data directly to the advanced charging case 410, the confirmation of the success or failure of adding the data may be indicated by the advanced charging case 410 based on its capabilities. For example, a light associated with the fingerprint sensor on the advanced charging case 410 may blink a particular color to indicate success or failure, the advanced charging case 410 may vibrate in a specific pattern to indicate success or failure, a display on the advanced charging case 410 (if equipped) may display a success or failure message, a speaker on the advanced charging case 410 (if equipped) may output an audible indication of success or failure, and/or the like.

In some cases, to make the mechanism illustrated in FIG. 4 more secure, the fingerprint data stored at the advanced charging case 410 can be encrypted with the EPK. As in the example of FIG. 3, the EPK is a shared user account key between the advanced charging case 410, the wireless device 430, and the wireless earbuds. This key would be shared by the wireless device 430 with the advanced charging case 410 over a wireless connection (e.g., a BLUETOOTH® connection).

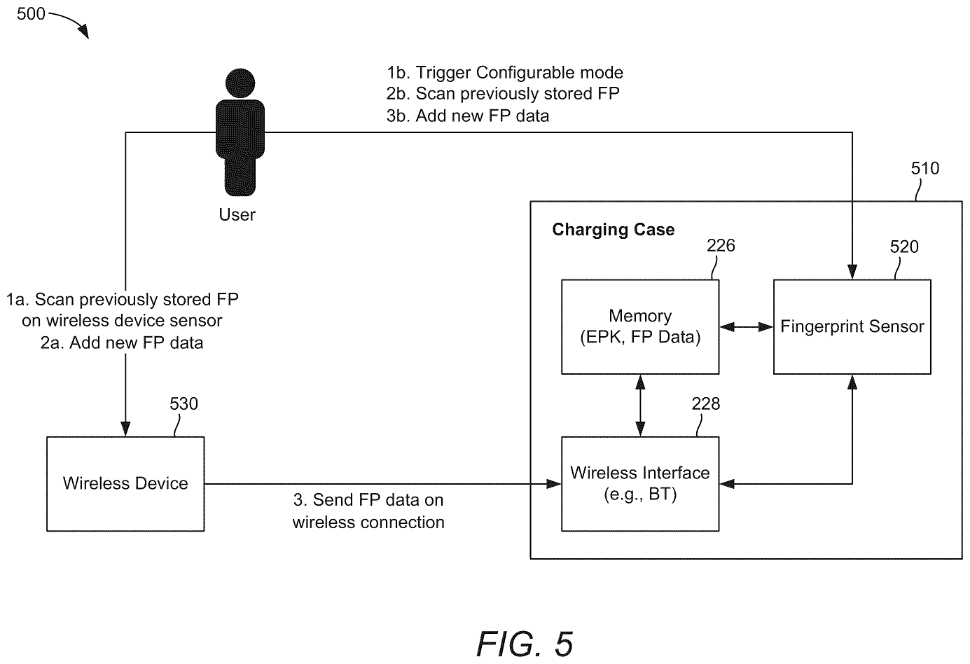

The fingerprint configuration sequence changes based on whether the advanced charging case 410 has stored fingerprint data. FIG. 5 is a diagram 500 illustrating a subsequent configuration of fingerprint data on an advanced charging case 510, according to aspects of the disclosure. The advanced charging case 510 may correspond to any of the advanced charging cases disclosed herein, such as the advanced charging case 310 and/or 410.

In the example of FIG. 5, an existing fingerprint is already stored in the memory of the advanced charging case 510, and either a new fingerprint needs to be added or the previous fingerprint needs to be replaced with a new one. Note that supporting multiple fingerprints on the same advanced charging case 510 is based on the capabilities of the advanced charging case 510.

Since the advanced charging case 510 is already secured with an existing fingerprint data, it is important to input the existing fingerprint before replacing it with a new fingerprint. A new fingerprint may be added in two ways based on where the fingerprint configuration is being performed. If the fingerprint configuration is being performed on the user's wireless device 530 (e.g., wireless device 330 and/or 430), then at stage 1a, the user scans the previously stored fingerprint using a fingerprint scanner on the wireless device 530. At stage 2a, the user scans a new fingerprint to add or to replace the existing fingerprint. At stage 3a, the wireless device sends the new fingerprint data to the advance charging case 510 over a wireless connection (e.g., a BLUETOOTH® connection).

If the fingerprint configuration is being performed on the advanced charging case 510, then at stage 1b, the advanced charging case 510 can be placed into configuration mode to change the existing fingerprint data or add new fingerprint data to the advanced charging case 510. Triggering the configuration mode may be accomplished using various methods. For example, the wireless device 530 may send a message to the advanced charging case 510 over a wireless connection to put the advanced charging case 510 into configuration mode. As another example, the user may provide input through the display screen of the wireless device in terms of a personal identification number (PIN) or the like. As another example, the user may perform a specific gesture (e.g., shaking) with the advanced charging case 510 to put the advanced charging case 510 into configurable mode. As yet another example, there may be a dedicated button on the advanced charging case 510 to activate configurable mode. As another example, a voice command may put the advanced charging case 510 into configurable mode. In this case, the detected voice command can be matched against the stored voice of the user, depending on the capabilities of the charging case (e.g., whether it has a microphone and the capability to voice match). As yet another example, the same fingerprint sensor may be used to put the advanced charging case 510 into configurable mode. For example, in this case, the user may touch and hold the fingerprint sensor with the sane fingerprint that was added before.

At stage 2b, the user scans the previously stored fingerprint using the fingerprint scanner 520 of the advanced charging case 510. Then, at stage 3b, the user can add a new fingerprint (if the advanced charging case 510 is capable of storing multiple fingerprints) or replace the existing fingerprint data.

There are additional out-of-band techniques that can be used for authentication between an advanced charging case and a pair of wireless earbuds, such as face-based authentication, image-based authentication, proximity-based authentication, and/or PIN-based authentication. With respect to face-based authentication, if the advanced charging case has a camera, facial recognition sensors may be included in the advanced charging case and these facial recognition sensors may be used instead of fingerprint to authenticate the user. Here, face-based authentication would use the same mechanism and signaling as the fingerprint-based authentication illustrated in FIGS. 4 and 5. Similarly, other image data may be used, such as a quick response (QR) code, security image, etc.

With respect to proximity-based authentication, if the user's wireless device is connected to the advanced charging case, the proximity of the wireless device to the advanced charging case can be used as an authenticating factor to permit the wireless earbuds to use the advanced charging case functionalities. The wireless user device may be determined to be proximate the advanced charging case based on the signal strength between the wireless user device and the advanced charging case being greater than a signal strength threshold, a challenge and response sequence between the wireless user device and the advanced charging case being performed/completed within a time constraint, a ranging procedure between the wireless user device and the advanced charging case indicating that the distance between the wireless user device and the advanced charging case is within a distance threshold, and/or the like.

With respect to PIN-based authentication, a PIN may be setup for the advanced charging case to authenticate the user. If the advanced charging case has a display, the PIN can be entered on it, otherwise, the PIN can be entered on the user's wireless device, which can transfer the PIN to the advanced charging case for authentication of the user.

Using the authentication mechanisms described herein, various use cases can be achieved for restricting access to some or all of the functionality of an advanced charging case. The following are a few example use cases. First, the authentication mechanisms described herein can deter charging case theft. For example, if the advanced charging case is stolen, it will be useless as the person who stole it will not be able to use any of the charging case functionality, possibly even including charging.

As a second use case, the authentication mechanisms described herein can be used to block charging. For example, a user may have purchased a new pair of wireless earbuds with a charging case that usually stays in a public area, such as an office desk, and the user wants to prevent others from charging their wireless earbuds. Here, the charging functionality itself can be set as a private service that requires authentication before usage.

As a third use case, the authentication mechanisms described herein can enable the advanced charging case to be used as a private speaker. For example, a user may have purchased an advanced charging case that provides speaker functionality and can receive commands from the associated earbuds. However, the user may not want anyone else to use the speaker functionality, which can be restricted using the authentication mechanisms described herein.

As a fourth use case, the authentication mechanisms described herein can be used to prevent display usage. For example, a user may have purchased an advanced charging case that has a touch display and does not want others to be able to use the touch display.

As a fifth use case, the authentication mechanisms described herein can be used to restrict sensor usage. For example, a user may have purchased an advanced charging case and does not want others to use various sensing mechanisms of the advanced charging case, such as light, temperature, etc.

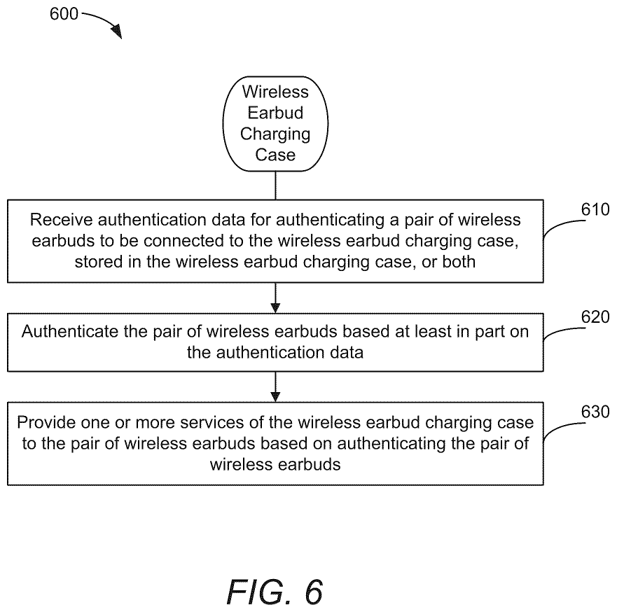

FIG. 6 illustrates an example method 600 of wireless communication, according to aspects of the disclosure. In an aspect, method 600 may be performed by a wireless earbud charging case (e.g., any of the advanced charging cases described herein, such as advanced charging case 310, 410, and/or 510).

At 610, the wireless earbud charging case receives authentication data for authenticating a pair of wireless earbuds (e.g., wireless earbuds 320) to be connected to the wireless earbud charging case, stored in the wireless earbud charging case, or both. In an aspect, operation 610 may be performed by, for example, the transceiver 220, the wireless interface 228, the fingerprint scanner 420/520, the processor 202, the BLUETOOTH® processor 224, and/or memory 226, any or all of which may be considered means for performing this operation.

At 620, the wireless earbud charging case authenticates the pair of wireless earbuds based at least in part on the authentication data. In an aspect, operation 620 may be performed by, for example, the transceiver 220, the wireless interface 228, the fingerprint scanner 420/520, the processor 202, the BLUETOOTH® processor 224, and/or memory 226, any or all of which may be considered means for performing this operation.

At 630, the wireless earbud charging case provides one or more services of the wireless earbud charging case to the pair of wireless earbuds based on authenticating the pair of wireless earbuds. In an aspect, operation 630 may be performed by, for example, the transceiver 220, the wireless interface 228, the fingerprint scanner 420/520, the processor 202, the BLUETOOTH® processor 224, and/or memory 226, any or all of which may be considered means for performing this operation.

As will be appreciated, a technical advantage of the method 600 is preventing unauthorized access to the wireless earbud charging case.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a wireless earbud charging case, comprising: receiving authentication data for authenticating a pair of wireless earbuds to be connected to the wireless earbud charging case, stored in the wireless earbud charging case, or both; authenticating the pair of wireless earbuds based at least in part on the authentication data; and providing one or more services of the wireless earbud charging case to the pair of wireless earbuds based on authenticating the pair of wireless earbuds.

Clause 2. The method of clause 1, further comprising: establishing a connection with a wireless user device associated with a user of the wireless earbud charging case, wherein the authentication data is received from the wireless user device via the connection.

Clause 3. The method of clause 2, wherein the connection with the wireless user device is a wired connection or a wireless connection.

Clause 4. The method of any of clauses 1 to 3, wherein the authentication data is received from a server.

Clause 5. The method of any of clauses 1 to 4, wherein the authentication data comprises: an address of the pair of wireless earbuds, an earbud pairing key (EPK), and a shared authorization secret.

Clause 6. The method of clause 5, wherein authenticating the pair of wireless earbuds comprises: establishing a wireless connection with the pair of wireless earbuds; receiving the EPK, the shared authorization secret, or both from the pair of wireless earbuds; and authenticating the pair of wireless earbuds based on reception of the EPK, the shared authorization secret, or both from the pair of wireless earbuds.

Clause 7. The method of any of clauses 5 to 6, wherein authenticating the pair of wireless earbuds comprises: establishing a wireless connection with the pair of wireless earbuds; transmitting the EPK, the shared authorization secret, or both to the pair of wireless earbuds; receiving an acknowledgment from the pair of wireless earbuds; and authenticating the pair of wireless earbuds based on reception of the acknowledgment from the pair of wireless earbuds.

Clause 8. The method of any of clauses 5 to 7, wherein authenticating the pair of wireless earbuds comprises: detecting a wired connection with the pair of wireless earbuds; receiving the EPK, the shared authorization secret, or both from the pair of wireless earbuds; and authenticating the pair of wireless earbuds based on reception of the EPK, the shared authorization secret, or both from the pair of wireless earbuds.

Clause 9. The method of any of clauses 5 to 8, wherein authenticating the pair of wireless earbuds comprises: detecting a wired connection with the pair of wireless earbuds; transmitting the EPK, the shared authorization secret, or both to the pair of wireless earbuds; receiving an acknowledgment from the pair of wireless earbuds; and authenticating the pair of wireless earbuds based on reception of the acknowledgment from the pair of wireless earbuds.

Clause 10. The method of any of clauses 1 to 9, further comprising: entering a configurable mode a first time; and receiving the authentication data while in the configurable mode.

Clause 11. The method of clause 10, wherein: the authentication data is received from a user of the wireless earbud charging case, or the authentication data is received from a wireless user device associated with the user of the wireless earbud charging case.

Clause 12. The method of any of clauses 10 to 11, wherein authenticating the pair of wireless earbuds comprises: receiving second authentication data; comparing the second authentication data to the authentication data; and authenticating the pair of wireless earbuds based on the second authentication data matching the authentication data.

Clause 13. The method of any of clauses 10 to 12, further comprising: entering the configurable mode a second time subsequent to the first time; receiving the authentication data while in the configurable mode; and receiving second authentication data subsequent to reception of the authentication data while in the configurable mode.

Clause 14. The method of clause 13, wherein: the second authentication data replaces the authentication data, or the second authentication data is in addition to the authentication data.

Clause 15. The method of any of clauses 10 to 14, wherein the authentication data comprises: fingerprint data of a user of the wireless earbud charging case, facial data of the user of the wireless earbud charging case, voice data of the user of the wireless earbud charging case, image data captured by the wireless earbud charging case, a personal identification number (PIN), or any combination thereof.

Clause 16. The method of any of clauses 1 to 15, wherein the authentication data comprises proximity data of a wireless user device associated with a user of the wireless earbud charging case.

Clause 17. The method of any of clauses 1 to 16, further comprising: receiving an indication of the one or more services.

Clause 18. The method of clause 17, wherein the indication is received: from a wireless user device associated with a user of the wireless earbud charging case, via interaction with the pair of wireless earbuds, or from a user account associated with the user via the wireless user device or the pair of wireless earbuds.

Clause 19. The method of any of clauses 17 to 18, wherein: the one or more services are all services provided by the wireless earbud charging case, or the one or more services are a subset of services provided by the wireless earbud charging case.

Clause 20. The method of any of clauses 1 to 19, wherein the one or more services comprise: a charging service, a fast charging service, a charge level service, a display screen service, a speaker service, a microphone service, a camera service, a fingerprint scanner service, a facial recognition service, or any combination thereof.

Clause 21. A wireless earbud charging case, comprising: one or more memories; one or more processors communicatively coupled to the one or more memories, the one or more processors, either alone or in combination, configured to: receive authentication data for authenticating a pair of wireless earbuds to be connected to the wireless earbud charging case, stored in the wireless earbud charging case, or both; authenticate the pair of wireless earbuds based at least in part on the authentication data; and provide one or more services of the wireless earbud charging case to the pair of wireless earbuds based on authenticating the pair of wireless earbuds.

Clause 22. The wireless earbud charging case of clause 21, wherein the one or more processors, either alone or in combination, are further configured to: establish a connection with a wireless user device associated with a user of the wireless earbud charging case, wherein the authentication data is received from the wireless user device via the connection.

Clause 23. The wireless earbud charging case of clause 22, wherein the connection with the wireless user device is a wired connection or a wireless connection.

Clause 24. The wireless earbud charging case of any of clauses 21 to 23, wherein the authentication data is received from a server.

Clause 25. The wireless earbud charging case of any of clauses 21 to 24, wherein the authentication data comprises: an address of the pair of wireless earbuds, an earbud pairing key (EPK), and a shared authorization secret.

Clause 26. The wireless earbud charging case of clause 25, wherein the one or more processors configured to authenticate the pair of wireless earbuds comprises the one or more processors, either alone or in combination, configured to: establish, via one or more transceivers of the wireless earbud charging case, a wireless connection with the pair of wireless earbuds; receive, via the one or more transceivers, the EPK, the shared authorization secret, or both from the pair of wireless earbuds; and authenticate the pair of wireless earbuds based on reception of the EPK, the shared authorization secret, or both from the pair of wireless earbuds.

Clause 27. The wireless earbud charging case of any of clauses 25 to 26, wherein the one or more processors configured to authenticate the pair of wireless earbuds comprises the one or more processors, either alone or in combination, configured to: establish, via one or more transceivers of the wireless earbud charging case, a wireless connection with the pair of wireless earbuds; transmit, via the one or more transceivers, the EPK, the shared authorization secret, or both to the pair of wireless earbuds; receive, via the one or more transceivers, an acknowledgment from the pair of wireless earbuds; and authenticate the pair of wireless earbuds based on reception of the acknowledgment from the pair of wireless earbuds.

Clause 28. The wireless earbud charging case of any of clauses 25 to 27, wherein the one or more processors configured to authenticate the pair of wireless earbuds comprises the one or more processors, either alone or in combination, configured to: detect a wired connection with the pair of wireless earbuds; receive the EPK, the shared authorization secret, or both from the pair of wireless earbuds; and authenticate the pair of wireless earbuds based on reception of the EPK, the shared authorization secret, or both from the pair of wireless earbuds.

Clause 29. The wireless earbud charging case of any of clauses 25 to 28, wherein the one or more processors configured to authenticate the pair of wireless earbuds comprises the one or more processors, either alone or in combination, configured to: detect a wired connection with the pair of wireless earbuds; transmit the EPK, the shared authorization secret, or both to the pair of wireless earbuds; receive an acknowledgment from the pair of wireless earbuds; and authenticate the pair of wireless earbuds based on reception of the acknowledgment from the pair of wireless earbuds.

Clause 30. The wireless earbud charging case of any of clauses 21 to 29, wherein the one or more processors, either alone or in combination, are further configured to: enter a configurable mode a first time; and receive the authentication data while in the configurable mode.

Clause 31. The wireless earbud charging case of clause 30, wherein: the authentication data is received from a user of the wireless earbud charging case, or the authentication data is received from a wireless user device associated with the user of the wireless earbud charging case.

Clause 32. The wireless earbud charging case of any of clauses 30 to 31, wherein the one or more processors configured to authenticate the pair of wireless earbuds comprises the one or more processors, either alone or in combination, configured to: receive second authentication data; compare the second authentication data to the authentication data; and authenticate the pair of wireless earbuds based on the second authentication data matching the authentication data.

Clause 33. The wireless earbud charging case of any of clauses 30 to 32, wherein the one or more processors, either alone or in combination, are further configured to: enter the configurable mode a second time subsequent to the first time; receive the authentication data while in the configurable mode; and receive second authentication data subsequent to reception of the authentication data while in the configurable mode.

Clause 34. The wireless earbud charging case of clause 33, wherein: the second authentication data replaces the authentication data, or the second authentication data is in addition to the authentication data.

Clause 35. The wireless earbud charging case of any of clauses 30 to 34, wherein the authentication data comprises: fingerprint data of a user of the wireless earbud charging case, facial data of the user of the wireless earbud charging case, voice data of the user of the wireless earbud charging case, image data captured by the wireless earbud charging case, a personal identification number (PIN), or any combination thereof.

Clause 36. The wireless earbud charging case of any of clauses 21 to 35, wherein the authentication data comprises proximity data of a wireless user device associated with a user of the wireless earbud charging case.

Clause 37. The wireless earbud charging case of any of clauses 21 to 36, wherein the one or more processors, either alone or in combination, are further configured to: receive an indication of the one or more services.

Clause 38. The wireless earbud charging case of clause 37, wherein the indication is received: from a wireless user device associated with a user of the wireless earbud charging case, via interaction with the pair of wireless earbuds, or from a user account associated with the user via the wireless user device or the pair of wireless earbuds.

Clause 39. The wireless earbud charging case of any of clauses 37 to 38, wherein: the one or more services are all services provided by the wireless earbud charging case, or the one or more services are a subset of services provided by the wireless earbud charging case.

Clause 40. The wireless earbud charging case of any of clauses 21 to 39, wherein the one or more services comprise: a charging service, a fast charging service, a charge level service, a display screen service, a speaker service, a microphone service, a camera service, a fingerprint scanner service, a facial recognition service, or any combination thereof.

Clause 41. A wireless earbud charging case, comprising: means for receiving authentication data for authenticating a pair of wireless earbuds to be connected to the wireless earbud charging case, stored in the wireless earbud charging case, or both; means for authenticating the pair of wireless earbuds based at least in part on the authentication data; and means for providing one or more services of the wireless earbud charging case to the pair of wireless earbuds based on authenticating the pair of wireless earbuds.

Clause 42. The wireless earbud charging case of clause 41, further comprising: means for establishing a connection with a wireless user device associated with a user of the wireless earbud charging case, wherein the authentication data is received from the wireless user device via the connection.

Clause 43. The wireless earbud charging case of clause 42, wherein the connection with the wireless user device is a wired connection or a wireless connection.

Clause 44. The wireless earbud charging case of any of clauses 41 to 43, wherein the authentication data is received from a server.

Clause 45. The wireless earbud charging case of any of clauses 41 to 44, wherein the authentication data comprises: an address of the pair of wireless earbuds, an earbud pairing key (EPK), and a shared authorization secret.

Clause 46. The wireless earbud charging case of clause 45, wherein the means for authenticating the pair of wireless earbuds comprises: means for establishing a wireless connection with the pair of wireless earbuds; means for receiving the EPK, the shared authorization secret, or both from the pair of wireless earbuds; and means for authenticating the pair of wireless earbuds based on reception of the EPK, the shared authorization secret, or both from the pair of wireless earbuds.

Clause 47. The wireless earbud charging case of any of clauses 45 to 46, wherein the means for authenticating the pair of wireless earbuds comprises: means for establishing a wireless connection with the pair of wireless earbuds; means for transmitting the EPK, the shared authorization secret, or both to the pair of wireless earbuds; means for receiving an acknowledgment from the pair of wireless earbuds; and means for authenticating the pair of wireless earbuds based on reception of the acknowledgment from the pair of wireless earbuds.

Clause 48. The wireless earbud charging case of any of clauses 45 to 47, wherein the means for authenticating the pair of wireless earbuds comprises: means for detecting a wired connection with the pair of wireless earbuds; means for receiving the EPK, the shared authorization secret, or both from the pair of wireless earbuds; and means for authenticating the pair of wireless earbuds based on reception of the EPK, the shared authorization secret, or both from the pair of wireless earbuds.

Clause 49. The wireless earbud charging case of any of clauses 45 to 48, wherein the means for authenticating the pair of wireless earbuds comprises: means for detecting a wired connection with the pair of wireless earbuds; means for transmitting the EPK, the shared authorization secret, or both to the pair of wireless earbuds; means for receiving an acknowledgment from the pair of wireless earbuds; and means for authenticating the pair of wireless earbuds based on reception of the acknowledgment from the pair of wireless earbuds.

Clause 50. The wireless earbud charging case of any of clauses 41 to 49, further comprising: means for entering a configurable mode a first time; and means for receiving the authentication data while in the configurable mode.

Clause 51. The wireless earbud charging case of clause 50, wherein: the authentication data is received from a user of the wireless earbud charging case, or the authentication data is received from a wireless user device associated with the user of the wireless earbud charging case.

Clause 52. The wireless earbud charging case of any of clauses 50 to 51, wherein the means for authenticating the pair of wireless earbuds comprises: means for receiving second authentication data; means for comparing the second authentication data to the authentication data; and means for authenticating the pair of wireless earbuds based on the second authentication data matching the authentication data.

Clause 53. The wireless earbud charging case of any of clauses 50 to 52, further comprising: means for entering the configurable mode a second time subsequent to the first time; means for receiving the authentication data while in the configurable mode; and means for receiving second authentication data subsequent to reception of the authentication data while in the configurable mode.

Clause 54. The wireless earbud charging case of clause 53, wherein: the second authentication data replaces the authentication data, or the second authentication data is in addition to the authentication data.

Clause 55. The wireless earbud charging case of any of clauses 50 to 54, wherein the authentication data comprises: means for fingerprinting data of a user of the wireless earbud charging case, facial data of the user of the wireless earbud charging case, voice data of the user of the wireless earbud charging case, means for imaging data captured by the wireless earbud charging case, a personal identification number (PIN), or any combination thereof.

Clause 56. The wireless earbud charging case of any of clauses 41 to 55, wherein the authentication data comprises proximity data of a wireless user device associated with a user of the wireless earbud charging case.

Clause 57. The wireless earbud charging case of any of clauses 41 to 56, further comprising: means for receiving an indication of the one or more services.

Clause 58. The wireless earbud charging case of clause 57, wherein the indication is received: from a wireless user device associated with a user of the wireless earbud charging case, via interaction with the pair of wireless earbuds, or from a user account associated with the user via the wireless user device or the pair of wireless earbuds.

Clause 59. The wireless earbud charging case of any of clauses 57 to 58, wherein: the one or more services are all services provided by the wireless earbud charging case, or the one or more services are a subset of services provided by the wireless earbud charging case.

Clause 60. The wireless earbud charging case of any of clauses 41 to 59, wherein the one or more services comprise: a charging service, a fast charging service, a charge level service, a display screen service, a speaker service, a microphone service, a camera service, a fingerprint scanner service, a facial recognition service, or any combination thereof.

Clause 61. A non-transitory computer-readable medium storing computer-executable instructions that, when executed by a wireless earbud charging case, cause the wireless earbud charging case to: receive authentication data for authenticating a pair of wireless earbuds to be connected to the wireless earbud charging case, stored in the wireless earbud charging case, or both; authenticate the pair of wireless earbuds based at least in part on the authentication data; and provide one or more services of the wireless earbud charging case to the pair of wireless earbuds based on authenticating the pair of wireless earbuds.

Clause 62. The non-transitory computer-readable medium of clause 61, further comprising computer-executable instructions that, when executed by the wireless earbud charging case, cause the wireless earbud charging case to: establish a connection with a wireless user device associated with a user of the wireless earbud charging case, wherein the authentication data is received from the wireless user device via the connection.

Clause 63. The non-transitory computer-readable medium of clause 62, wherein the connection with the wireless user device is a wired connection or a wireless connection.

Clause 64. The non-transitory computer-readable medium of any of clauses 61 to 63, wherein the authentication data is received from a server.

Clause 65. The non-transitory computer-readable medium of any of clauses 61 to 64, wherein the authentication data comprises: an address of the pair of wireless earbuds, an earbud pairing key (EPK), and a shared authorization secret.

Clause 66. The non-transitory computer-readable medium of clause 65, wherein the computer-executable instructions that, when executed by the wireless earbud charging case, cause the wireless earbud charging case to authenticate the pair of wireless earbuds comprise computer-executable instructions that, when executed by the wireless earbud charging case, cause the wireless earbud charging case to: establish a wireless connection with the pair of wireless earbuds; receive the EPK, the shared authorization secret, or both from the pair of wireless earbuds; and authenticate the pair of wireless earbuds based on reception of the EPK, the shared authorization secret, or both from the pair of wireless earbuds.

Clause 67. The non-transitory computer-readable medium of any of clauses 65 to 66, wherein the computer-executable instructions that, when executed by the wireless earbud charging case, cause the wireless earbud charging case to authenticate the pair of wireless earbuds comprise computer-executable instructions that, when executed by the wireless earbud charging case, cause the wireless earbud charging case to: establish a wireless connection with the pair of wireless earbuds; transmit the EPK, the shared authorization secret, or both to the pair of wireless earbuds; receive an acknowledgment from the pair of wireless earbuds; and authenticate the pair of wireless earbuds based on reception of the acknowledgment from the pair of wireless earbuds.

Clause 68. The non-transitory computer-readable medium of any of clauses 65 to 67, wherein the computer-executable instructions that, when executed by the wireless earbud charging case, cause the wireless earbud charging case to authenticate the pair of wireless earbuds comprise computer-executable instructions that, when executed by the wireless earbud charging case, cause the wireless earbud charging case to: detect a wired connection with the pair of wireless earbuds; receive the EPK, the shared authorization secret, or both from the pair of wireless earbuds; and authenticate the pair of wireless earbuds based on reception of the EPK, the shared authorization secret, or both from the pair of wireless earbuds.

Clause 69. The non-transitory computer-readable medium of any of clauses 65 to 68, wherein the computer-executable instructions that, when executed by the wireless earbud charging case, cause the wireless earbud charging case to authenticate the pair of wireless earbuds comprise computer-executable instructions that, when executed by the wireless earbud charging case, cause the wireless earbud charging case to: detect a wired connection with the pair of wireless earbuds; transmit the EPK, the shared authorization secret, or both to the pair of wireless earbuds; receive an acknowledgment from the pair of wireless earbuds; and authenticate the pair of wireless earbuds based on reception of the acknowledgment from the pair of wireless earbuds.

Clause 70. The non-transitory computer-readable medium of any of clauses 61 to 69, further comprising computer-executable instructions that, when executed by the wireless earbud charging case, cause the wireless earbud charging case to: enter a configurable mode a first time; and receive the authentication data while in the configurable mode.

Clause 71. The non-transitory computer-readable medium of clause 70, wherein: the authentication data is received from a user of the wireless earbud charging case, or the authentication data is received from a wireless user device associated with the user of the wireless earbud charging case.

Clause 72. The non-transitory computer-readable medium of any of clauses 70 to 71, wherein the computer-executable instructions that, when executed by the wireless earbud charging case, cause the wireless earbud charging case to authenticate the pair of wireless earbuds comprise computer-executable instructions that, when executed by the wireless earbud charging case, cause the wireless earbud charging case to: receive second authentication data; compare the second authentication data to the authentication data; and authenticate the pair of wireless earbuds based on the second authentication data matching the authentication data.

Clause 73. The non-transitory computer-readable medium of any of clauses 70 to 72, further comprising computer-executable instructions that, when executed by the wireless earbud charging case, cause the wireless earbud charging case to: enter the configurable mode a second time subsequent to the first time; receive the authentication data while in the configurable mode; and receive second authentication data subsequent to reception of the authentication data while in the configurable mode.

Clause 74. The non-transitory computer-readable medium of clause 73, wherein: the second authentication data replaces the authentication data, or the second authentication data is in addition to the authentication data.

Clause 75. The non-transitory computer-readable medium of any of clauses 70 to 74, wherein the authentication data comprises: fingerprint data of a user of the wireless earbud charging case, facial data of the user of the wireless earbud charging case, voice data of the user of the wireless earbud charging case, image data captured by the wireless earbud charging case, a personal identification number (PIN), or any combination thereof.

Clause 76. The non-transitory computer-readable medium of any of clauses 61 to 75, wherein the authentication data comprises proximity data of a wireless user device associated with a user of the wireless earbud charging case.

Clause 77. The non-transitory computer-readable medium of any of clauses 61 to 76, further comprising computer-executable instructions that, when executed by the wireless earbud charging case, cause the wireless earbud charging case to: receive an indication of the one or more services.

Clause 78. The non-transitory computer-readable medium of clause 77, wherein the indication is received: from a wireless user device associated with a user of the wireless earbud charging case, via interaction with the pair of wireless earbuds, or from a user account associated with the user via the wireless user device or the pair of wireless earbuds.

Clause 79. The non-transitory computer-readable medium of any of clauses 77 to 78, wherein: the one or more services are all services provided by the wireless earbud charging case, or the one or more services are a subset of services provided by the wireless earbud charging case.

Clause 80. The non-transitory computer-readable medium of any of clauses 61 to 79, wherein the one or more services comprise: a charging service, a fast charging service, a charge level service, a display screen service, a speaker service, a microphone service, a camera service, a fingerprint scanner service, a facial recognition service, or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, a field programmable gate array (FPGA), or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a wireless earbud charging case, comprising:
receiving authentication data for authenticating a pair of wireless earbuds to be connected to the wireless earbud charging case, stored in the wireless earbud charging case, or both;
authenticating the pair of wireless earbuds based at least in part on the authentication data; and
providing one or more services of the wireless earbud charging case to the pair of wireless earbuds based on authenticating the pair of wireless earbuds.

2. The method of claim 1, further comprising:
establishing a connection with a wireless user device associated with a user of the wireless earbud charging case, wherein the authentication data is received from the wireless user device via the connection.

3. The method of claim 1, wherein the authentication data is received from a server.

4. The method of claim 1, wherein the authentication data comprises:
an address of the pair of wireless earbuds,
an earbud pairing key (EPK), and
a shared authorization secret.

5. The method of claim 1, further comprising:
entering a configurable mode a first time; and
receiving the authentication data while in the configurable mode.

6. The method of claim 1, wherein the authentication data comprises proximity data of a wireless user device associated with a user of the wireless earbud charging case.

7. The method of claim 1, further comprising:
receiving an indication of the one or more services.

8. The method of claim 1, wherein the one or more services comprise:
a charging service,
a fast charging service,
a charge level service,
a display screen service,
a speaker service,
a microphone service,
a camera service,
a fingerprint scanner service,
a facial recognition service, or
any combination thereof.

9. A wireless earbud charging case, comprising:
one or more memories;
one or more processors communicatively coupled to the one or more memories, the one or more processors, either alone or in combination, configured to:
receive authentication data for authenticating a pair of wireless earbuds to be connected to the wireless earbud charging case, stored in the wireless earbud charging case, or both;
authenticate the pair of wireless earbuds based at least in part on the authentication data; and
provide one or more services of the wireless earbud charging case to the pair of wireless earbuds based on authenticating the pair of wireless earbuds.

10. The wireless earbud charging case of claim 9, wherein the one or more processors, either alone or in combination, are further configured to:
establish a connection with a wireless user device associated with a user of the wireless earbud charging case, wherein the authentication data is received from the wireless user device via the connection.

11. The wireless earbud charging case of claim 10, wherein the connection with the wireless user device is a wired connection or a wireless connection.

12. The wireless earbud charging case of claim 9, wherein the authentication data is received from a server.

13. The wireless earbud charging case of claim 9, wherein the authentication data comprises:
an address of the pair of wireless earbuds,
an earbud pairing key (EPK), and
a shared authorization secret.

14. The wireless earbud charging case of claim 13, wherein the one or more processors configured to authenticate the pair of wireless earbuds comprises the one or more processors, either alone or in combination, configured to:
establish, via one or more transceivers of the wireless earbud charging case, a wireless connection with the pair of wireless earbuds;
receive, via the one or more transceivers, the EPK, the shared authorization secret, or both from the pair of wireless earbuds; and
authenticate the pair of wireless earbuds based on reception of the EPK, the shared authorization secret, or both from the pair of wireless earbuds.

15. The wireless earbud charging case of claim 13, wherein the one or more processors configured to authenticate the pair of wireless earbuds comprises the one or more processors, either alone or in combination, configured to:
establish, via one or more transceivers of the wireless earbud charging case, a wireless connection with the pair of wireless earbuds;
transmit, via the one or more transceivers, the EPK, the shared authorization secret, or both to the pair of wireless earbuds;
receive, via the one or more transceivers, an acknowledgment from the pair of wireless earbuds; and
authenticate the pair of wireless earbuds based on reception of the acknowledgment from the pair of wireless earbuds.

16. The wireless earbud charging case of claim 13, wherein the one or more processors configured to authenticate the pair of wireless earbuds comprises the one or more processors, either alone or in combination, configured to:
detect a wired connection with the pair of wireless earbuds;
receive the EPK, the shared authorization secret, or both from the pair of wireless earbuds; and
authenticate the pair of wireless earbuds based on reception of the EPK, the shared authorization secret, or both from the pair of wireless earbuds.

17. The wireless earbud charging case of claim 13, wherein the one or more processors configured to authenticate the pair of wireless earbuds comprises the one or more processors, either alone or in combination, configured to:
detect a wired connection with the pair of wireless earbuds;
transmit the EPK, the shared authorization secret, or both to the pair of wireless earbuds;
receive an acknowledgment from the pair of wireless earbuds; and
authenticate the pair of wireless earbuds based on reception of the acknowledgment from the pair of wireless earbuds.

18. The wireless earbud charging case of claim 9, wherein the one or more processors, either alone or in combination, are further configured to:
enter a configurable mode a first time; and
receive the authentication data while in the configurable mode.

19. The wireless earbud charging case of claim 18, wherein:
the authentication data is received from a user of the wireless earbud charging case, or
the authentication data is received from a wireless user device associated with the user of the wireless earbud charging case.

20. The wireless earbud charging case of claim 18, wherein the one or more processors configured to authenticate the pair of wireless earbuds comprises the one or more processors, either alone or in combination, configured to:
receive second authentication data;
compare the second authentication data to the authentication data; and
authenticate the pair of wireless earbuds based on the second authentication data matching the authentication data.

21. The wireless earbud charging case of claim 18, wherein the one or more processors, either alone or in combination, are further configured to:
enter the configurable mode a second time subsequent to the first time;
receive the authentication data while in the configurable mode; and
receive second authentication data subsequent to reception of the authentication data while in the configurable mode.

22. The wireless earbud charging case of claim 21, wherein:
the second authentication data replaces the authentication data, or
the second authentication data is in addition to the authentication data.

23. The wireless earbud charging case of claim 18, wherein the authentication data comprises:
fingerprint data of a user of the wireless earbud charging case,
facial data of the user of the wireless earbud charging case,
voice data of the user of the wireless earbud charging case,
image data captured by the wireless earbud charging case,
a personal identification number (PIN), or
any combination thereof.

24. The wireless earbud charging case of claim 9, wherein the authentication data comprises proximity data of a wireless user device associated with a user of the wireless earbud charging case.

25. The wireless earbud charging case of claim 9, wherein the one or more processors, either alone or in combination, are further configured to:
receive an indication of the one or more services.

26. The wireless earbud charging case of claim 25, wherein the indication is received:
from a wireless user device associated with a user of the wireless earbud charging case,
via interaction with the pair of wireless earbuds, or
from a user account associated with the user via the wireless user device or the pair of wireless earbuds.

27. The wireless earbud charging case of claim 25, wherein:
the one or more services are all services provided by the wireless earbud charging case, or
the one or more services are a subset of services provided by the wireless earbud charging case.

28. The wireless earbud charging case of claim 9, wherein the one or more services comprise:
a charging service,
a fast charging service,
a charge level service,
a display screen service,
a speaker service,
a microphone service,
a camera service,
a fingerprint scanner service,
a facial recognition service, or
any combination thereof.

29. A wireless earbud charging case, comprising:
means for receiving authentication data for authenticating a pair of wireless earbuds to be connected to the wireless earbud charging case, stored in the wireless earbud charging case, or both;
means for authenticating the pair of wireless earbuds based at least in part on the authentication data; and
means for providing one or more services of the wireless earbud charging case to the pair of wireless earbuds based on authenticating the pair of wireless earbuds.

30. A non-transitory computer-readable medium storing computer-executable instructions that, when executed by a wireless earbud charging case, cause the wireless earbud charging case to:
receive authentication data for authenticating a pair of wireless earbuds to be connected to the wireless earbud charging case, stored in the wireless earbud charging case, or both;
authenticate the pair of wireless earbuds based at least in part on the authentication data; and
provide one or more services of the wireless earbud charging case to the pair of wireless earbuds based on authenticating the pair of wireless earbuds.
